(19) United States
(12) Patent Application Publication
(10) Pub. No.: US 2026/0280982 A1
(43) Pub. Date: Sep. 17, 2026

(54) INFORMATION PROCESSING APPARATUS, CONTROL METHOD OF INFORMATION PROCESSING APPARATUS, AND STORAGE MEDIUM

(71) Applicant: Canon Kabushiki Kaisha, Tokyo (JP)

(72) Inventor: YUKI KANAGAWA, Chiba (JP)

(21) Appl. No.: 19/560,252

(22) Filed: Mar. 9, 2026

(30) Foreign Application Priority Data
Mar. 17, 2025 (JP) 2025-042716

(51) Int. Cl. H04L 41/0823; H04L 9/40

(52) U.S. Cl. CPC H04L 41/0823; H04L 63/20

(57) ABSTRACT

An information processing apparatus connectable to a plurality of networks includes: an obtaining unit configured to obtain information on a logged-in user; and a display control unit configured to perform display control of displaying information on the plurality of networks in a first mode in a case where the information on the user obtained by the obtaining unit is first user information, and displaying the information on the plurality of networks in a second mode different from the first mode in a case where the information on the user obtained by the obtaining unit is second user information different from the first user information.

### BACKGROUND

### Field of the Technology

The present disclosure relates to an information processing apparatus, a control method of an information processing apparatus, and a storage medium.

### Description of the Related Art

Devices that can form two networks such as a main line and a sub-line are appearing in the market in recent years. Japanese Patent Laid-Open No. 2023-024805 describes a technique in which, in a case where duplication of IP addresses of a main line and a sub-line occurs in a two-network configuration, a network of the sub-line is disabled.

There is a demand for improving usability in a multiple-network configuration.

### SUMMARY

An information processing apparatus according to one aspect of the present disclosure is an information processing apparatus connectable to a plurality of networks, and includes: an obtaining unit configured to obtain information on a logged-in user; and a display control unit configured to perform display control of displaying information on the plurality of networks in a first mode in a case where the information on the user obtained by the obtaining unit is first user information, and displaying the information on the plurality of networks in a second mode different from the first mode in a case where the information on the user obtained by the obtaining unit is second user information different from the first user information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a system configuration including an information processing apparatus;

FIG. 2 is a block diagram schematically illustrating a configuration of a controller unit;

FIG. 3 is a block diagram schematically illustrating a configuration of software modules;

FIG. 4 is a diagram illustrating an example of a menu screen;

FIGS. 5A and 5B are diagrams illustrating examples of a setting screen;

FIG. 6 is a diagram illustrating an example of an interface selection screen;

FIGS. 7A and 7B are diagrams illustrating examples of screens;

FIG. 8 is a flowchart illustrating an example of a process of determining network information to be displayed;

FIGS. 9A and 9B are diagrams illustrating examples of the menu screen;

FIG. 10 is a diagram illustrating examples of a pattern of the icon;

FIGS. 11A and 11B are diagrams illustrating examples of a network information screen;

FIG. 12 is a diagram explaining an example in which a display mode that differs depending on a radio field intensity is illustrated as an icon;

FIGS. 13A and 13B are diagrams illustrating examples of the network information screen;

FIG. 14 is a flowchart illustrating an example of the process of determining the network information to be displayed;

FIGS. 15A and 15B are diagrams illustrating examples of a screen in which privileges of the network information are set;

FIGS. 16A and 16B are diagrams illustrating examples of the screen in which the privileges of the network information are set;

FIGS. 17A and 17B are diagrams illustrating other examples of the screen in which the privileges of the network information are set;

FIG. 18 is a diagram illustrating an example of a setting screen in which a screen for displaying the network information is set; and

FIGS. 19A and 19B are diagrams illustrating examples of a position where the network information is displayed.

### DESCRIPTION OF THE EMBODIMENTS

Favorable embodiments of the present disclosure are explained below in detail with reference to the attached diagrams. Note that the following embodiments do not limit matters of the present disclosure, and not all of combinations of features explained in the following embodiments are necessarily essential for solving means of the present disclosure. Note that identical constituent elements are denoted by identical reference numerals.

### First Embodiment

### Outline

In recent years, a demand to know a connection state with a wireless LAN (that is radio field intensity) is increasing with popularization of wireless LAN devices. Moreover, a product that displays the radio field intensity on a top screen (for example, a home screen in which icons of applications are arranged) of an information processing apparatus such as an electronic device has appeared. For example, displaying the radio field intensity of the wireless LAN on the home screen that is first checked by a user in an operation of the information processing apparatus allows the user to promptly grasp the connection state without performing operations such as moving through a hierarchy to a setting screen in which the connection state is displayed.

Moreover, a device with a configuration in which networks such as a main network and a sub-network are separated from each other as a measure against information leakage has appeared. For example, there is a device that can form two networks of a main line and a sub-line.

Furthermore, in a multifunction peripheral that is one type of information processing apparatus, there is a form of a multifunction peripheral in which an administrator, a regular user, and many unspecified users including a guest user log into and operate the multifunction peripheral. Moreover, in such a form, the administrator sometimes determines the line to be used by each user. For example, there is a case where the administrator sets the line to be used in such a way that the main line is used by the regular user and the sub-line is used by the guest user. In this case, the user uses the multifunction peripheral without paying particular attention to the line which the user is using.

In this case, displaying connection statuses of the multiple networks to all users in the same way means disclosing more information than necessary to the users. In this case, the user needs to determine which information is information to be read by the user, by himself/herself. Accordingly, usability may decrease for a user who normally does not pay particular attention to the line which he/she regularly uses or a user who does not have to pay attention to the regularly-used line, in the case where more information than necessary is displayed.

Accordingly, in the present embodiment, control is performed such that display of connection information of multiple networks differs depending on a role of a user logged in an information processing apparatus. This can suppress a decrease in usability. Specifically, it is possible to perform information display that includes no information unnecessary to the logged-in user and that is easily understandable to the logged-in user.

### System Configuration

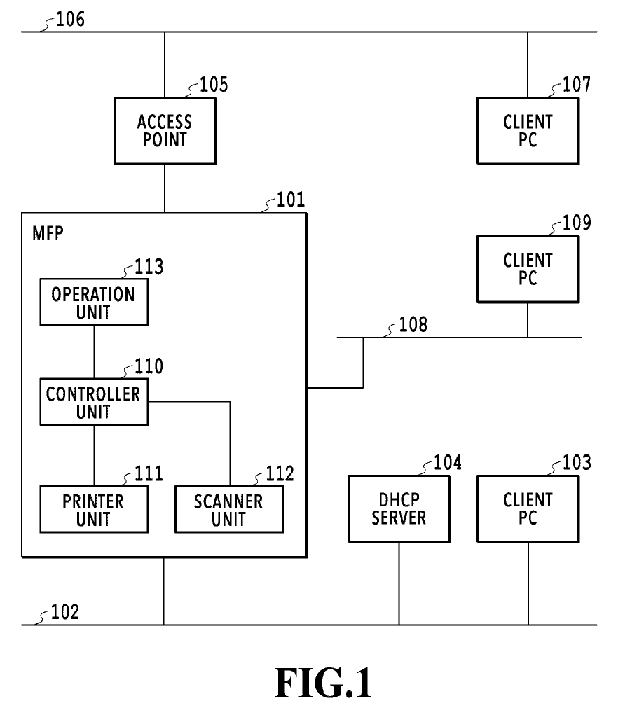

FIG. 1 is a block diagram illustrating an example of a system configuration including an information processing apparatus in the present embodiment. In the present embodiment, the information processing apparatus is assumed to be a multifunction peripheral (MFP) 101. Note that the information processing apparatus is not limited to the MFP, and may be, for example, a mobile phone, a personal computer (PC), a tablet terminal, a server, a personal digital assistant (PDA), or the like. Alternatively, various devices such as a digital camera, an audio reproduction device, and a television set can be adopted as the information processing apparatus.

In FIG. 1, the MFP 101 are connected to a client PC 103 and a DHCP server 104 that are communication apparatuses over a LAN 102 in wired infrastructure by using wired cables. The MFP 101 communicates with the client PC 103 and the DHCP server 104 by using a wired LAN. In the LAN 102, the dynamic host configuration protocol (DHCP) server 104 assigns an IP address to each of the MFP 101 and the client PC 103. For example, the client PC 103 accesses the MFP 101 by designating the IP address of the MFP 101 assigned by the DHCP server 104, and starts data communication with the MFP 101. Moreover, the MFP 101 is configured to be capable of performing wireless LAN communication. The MFP 101 performs communication using a wireless LAN with a client PC 107 that is a communication apparatus, via a communicably-connected access point 105 over a LAN 106 in wireless infrastructure. Moreover, the MFP 101 itself functions as an access point, and performs direct wireless communication with a client PC 109 that is a communication apparatus, over a LAN 108.

The MFP 101 is provided with multiple lines. In the present embodiment, explanation is given by using a configuration in which the MFP 101 includes one main line and one sub-line as an example. It is assumed that the MFP 101 can simultaneously operate the wired infrastructure and the wireless infrastructure, and one of the wired infrastructure and the wireless infrastructure is used as the main line while the other is used as the sub-line.

The configuration of the MFP 101 is explained. The MFP 101 includes a controller unit 110, a printer unit 111, a scanner unit 112, and an operation unit 113. The controller unit 110 is connected to the printer unit 111, the scanner unit 112, and the operation unit 113.

The controller unit 110 integrally controls the entire MFP 101. The printer unit 111 performs printing on a sheet based on print data received from the communication apparatuses such as the client PCs 103, 107, 109, and the like. The scanner unit 112 generates image data by scanning an original. The operation unit 113 includes a display unit, multiple operation keys, and the like. For example, the operation unit 113 displays an operation screen for performing each of settings of the MFP 101 on the display unit, and receives instructions inputted by the user operating the operation keys. For example, the operation unit 113 is a touch panel.

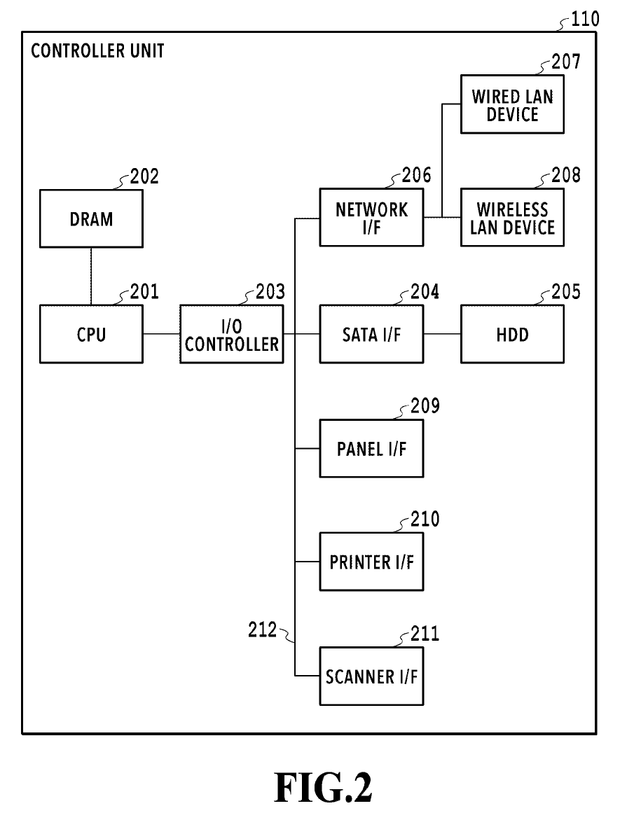

FIG. 2 is a block diagram schematically illustrating a configuration of the controller unit 110 of FIG. 1. The controller unit 110 includes a CPU 201, a DRAM 202, an I/O controller 203, a SATA I/F 204, an HDD 205, a network I/F 206, a wired LAN device 207, and a wireless LAN device 208. Moreover, the controller unit 110 includes a panel I/F 209, a printer I/F 210, and a scanner I/F 211. The CPU 201 is connected to the DRAM 202 and the I/O controller 203. The I/O controller 203, the SATA I/F 204, the network I/F 206, the panel I/F 209, the printer I/F 210, and the scanner I/F 211 are connected to one another via a bus 212. The SATA I/F 204 is connected to the HDD 205. The network I/F 206 is connected to the wired LAN device 207 and the wireless LAN device 208.

The CPU 201 executes a calculation process for performing each of controls in the controller unit 110, and transmits each of control instructions to the I/O controller 203. The DRAM 202 is used as a work area of the CPU 201 or as a temporal storage area of pieces of data. The I/O controller 203 transfers the control instruction made by the CPU 201 to each of the constituent elements connected via the bus 212. The SATA I/F 204 performs control of writing data into the HDD 205 and control of reading data stored in the HDD 205 according to the control instruction made by the CPU 201. The HDD 205 stores the image data, a program for implementing each of functions of the MFP 101, and the like.

The network I/F 206 controls each of the wired LAN device 207 and the wireless LAN device 208 according to the control instruction made by the CPU 201. The wired LAN device 207 controls the wired LAN communication performed with the client PC 103 and the like forming the LAN 102 in the wired infrastructure. The wireless LAN device 208 has a wireless infrastructure mode and a wireless access point mode. In the wireless infrastructure mode, wireless LAN communication is performed with the client PC 107 forming the LAN 106 in the wireless infrastructure via the access point 105. In the wireless access point mode, the MFP 101 functions as the access point, and direct wireless communication with the client PC 109 forming the LAN 108 is performed.

The panel I/F 209 performs display control in the operation unit 113 according to the control instruction made by the CPU 201, and also transfers, to the CPU 201, contents of an instruction inputted by the user performing an operation on the operation unit 113. The printer I/F 210 causes the printer unit 111 to execute print processing according to the control instruction made by the CPU 201. Note that a printing method of the printer unit 111 may be an electrophotographic method, an inkjet method, or any other method. In the case of the inkjet method, there may be adopted printing means in which printing is executed by using inks supplied from cartridges. Alternatively, there may be adopted printing means in which printing is executed by using inks contained in ink tanks provided in the inkjet printing apparatus, the inks contained by replenishment of the inks into the ink tanks instead of replacement of the cartridges including the inks. The scanner I/F 211 causes the scanner unit 112 to execute scan processing according to the control instruction made by the CPU 201.

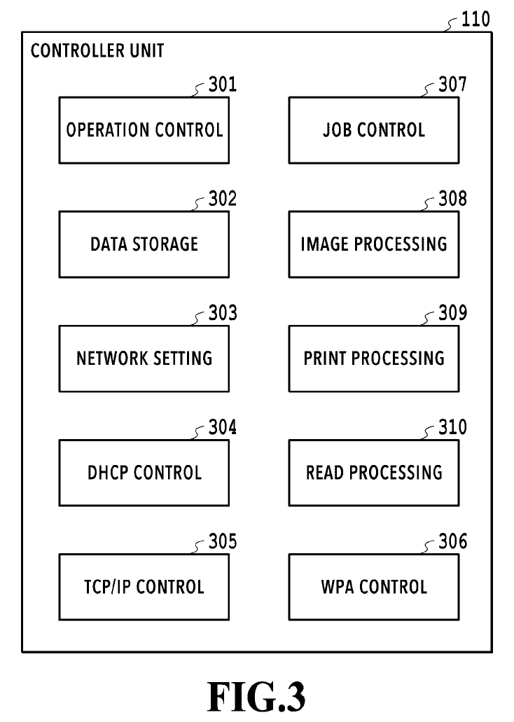

FIG. 3 is a block diagram schematically illustrating a configuration of software modules controlled by the controller unit 110 in FIG. 1.

The controller unit 110 includes an operation control module 301, a data storage module 302, a network setting module 303, a DHCP control module 304, and a TCP/IP control module 305. Moreover, the controller unit 110 includes a Wi-Fi protected access (WPA) control module 306, a job control module 307, an image processing module 308, a print processing module 309, and a read processing module 310. The CPU 201 performs control of each of the above-mentioned modules by executing a program stored in the HDD 205.

The operation control module 301 performs the display control of the operation screen and the like in the operation unit 113, and receives operations performed by the user on the operation screen or the operation keys. The data storage module 302 performs control of writing data such as setting values into the HDD 205, and performs control of reading out data stored in the HDD 205. The network setting module 303 performs control relating to network setting of the MFP 101, and requests the DHCP control module 304, the WPA control module 306, and the like to perform processes. For example, in the case where the user performs setting of using the IP address assigned by the DHCP server 104 as address information of the MFP 101, the network setting module 303 requests the DHCP control module 304 to perform a process. The DHCP control module 304 controls a process of assigning the IP address according to a protocol defined in RFC 2131 as DHCP. The TCP/IP control module 305 performs a process of exchanging network packets. In the case where the WPA control module 306 receives a request from the network setting module 303, the WPA control module 306 performs a wireless access authentication process according to a predetermined encryption method, for example, WPA protocol. Note that, although explanation is given based on an example in which an encryption method of WPA-PSK is used in the case where the wireless LAN communication is performed in the present embodiment, the encryption method is not limited to this example. For example, the encryption method may be other encryption methods such as WEP or WPA-EAP. Alternatively, a form in which no encryption method is used in the wireless LAN communication may be adopted.

The job control module 307 performs control relating to execution of jobs. The job control module 307 instructs the image processing module 308, the print processing module 309, and the read processing module 310 to execute processes relating to the jobs. In the case where the image processing module 308 receives the execution instruction from the job control module 307, the image processing module 308 executes image processing, for example, processes the image data into a data format suitable for each application. In the case where the print processing module 309 receives the execution instruction from the job control module 307, the print processing module 309 executes the print processing by controlling the printer unit 111. In the case where the read processing module 310 receives the execution instruction from the job control module 307, the read processing module 310 executes the scan processing by controlling the scanner unit 112.

### Screen Example

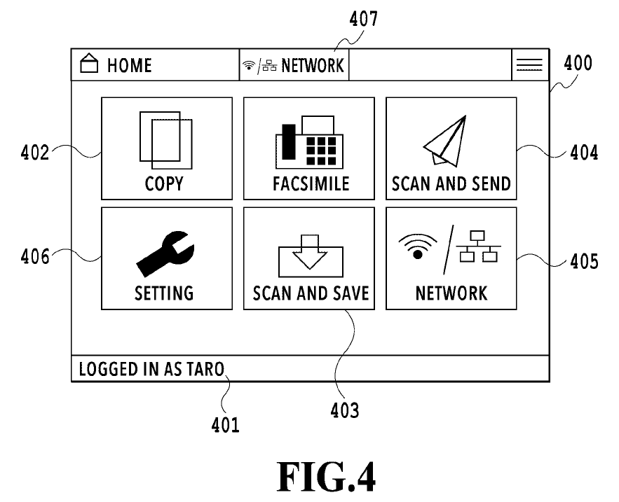

FIG. 4 is a diagram illustrating an example of a menu screen 400 displayed on the operation unit 113. The menu screen 400 is an operation screen that is used by the user to select each of functions of the MFP 101. The menu screen 400 is a home screen of the MFP 101. The menu screen 400 includes an information notification region 401, a copy button 402, a scan-and-save button 403, a scan-and-send button 404, a network button 405, a setting button 406, and a shortcut button 407. Each of the buttons is a button that receives operations of activating a corresponding application or setting. Specifically, the menu screen 400 is also a home screen in which icons of applications are arranged.

Each of notifications for the user is displayed in the information notification region 401. In the example of FIG. 4, notification of information on the login user is made. The copy button 402 is selected in the case where the user uses a copy function. The scan-and-save button 403 is selected in the case where the user uses a function of saving the image data obtained in scanning by the MFP 101. The scan-and-send button 404 is selected in the case where the user uses a function of sending the image data obtained in scanning by the MFP 101 to a communication apparatus.

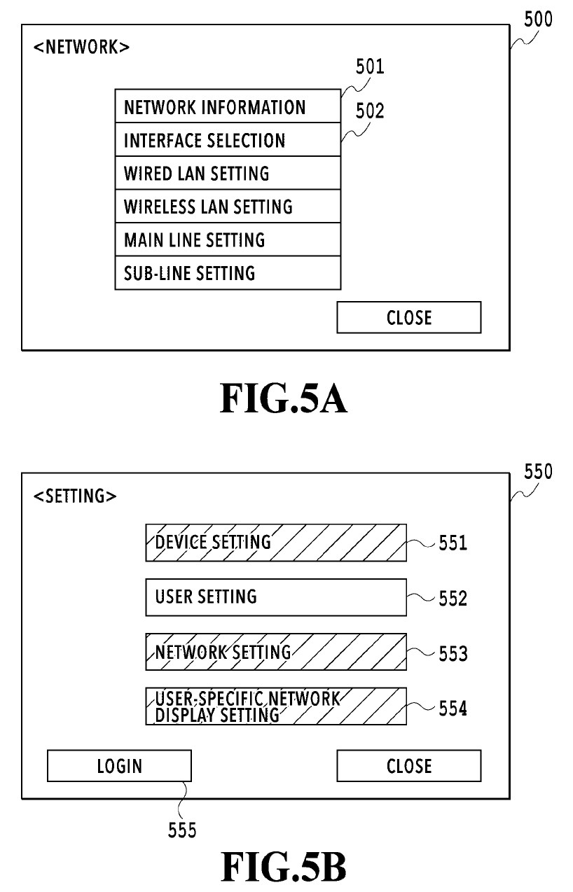

The network button 405 is selected in the case where the user checks information relating to the networks of the MFP 101 or changes settings relating to the networks. In the present embodiment, the display mode of the network button 405 differs depending on the role of the user. The example of FIG. 4 is an example of a display mode in the case where the administrator is logged in. In the network button 405, there is displayed a button icon in a display mode determined according to a process of a flowchart and setting values set in a setting screen to be described later. Details are described later. In the case where the user selects the network button 405, a network setting screen 500 illustrated in FIG. 5A to be described later is displayed in the operation unit 113.

The setting button 406 is selected in the case where the user changes each of settings of the MFP 101. In the case where the user selects the setting button 406 in the menu screen 400, a setting screen 550 in FIG. 5B to be described later is displayed in the operation unit 113. The shortcut button 407 is a function that allows a link to a function desired to be accessed in shortcut by the user to be always displayed in an upper area. For example, the shortcut button 407 continues to be displayed in the upper area of the screen of the operation unit 113 also in the case where the screen of the operation unit 113 transitions from the menu screen 400. The menu screen 400 of FIG. 4 is in a state where a link to the network setting screen 500 is set in the shortcut button 407. In this case, reception of pressing of the shortcut button 407 allows transition to the network setting screen 500 without transition to the menu screen 400. In the case where a link to the network is set in the shortcut button 407, the icon of the shortcut button 407 displays contents equivalent to the icon displayed in the network button 405. As described later, in the MFP 101 of the present embodiment, a display mode of the network button 405 differs depending on the role of the login user. Accordingly, a display mode of the icon of the shortcut button 407 in which the link to the network setting screen 500 is set also differs depending on the role of the login user.

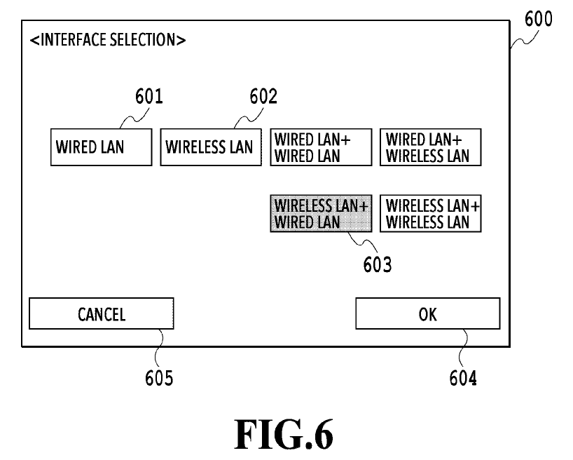

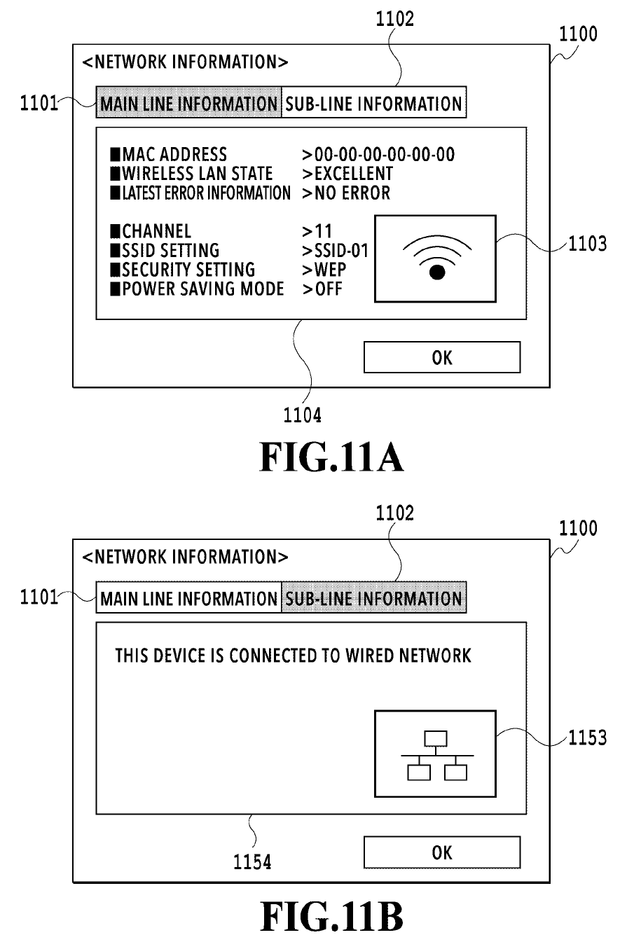

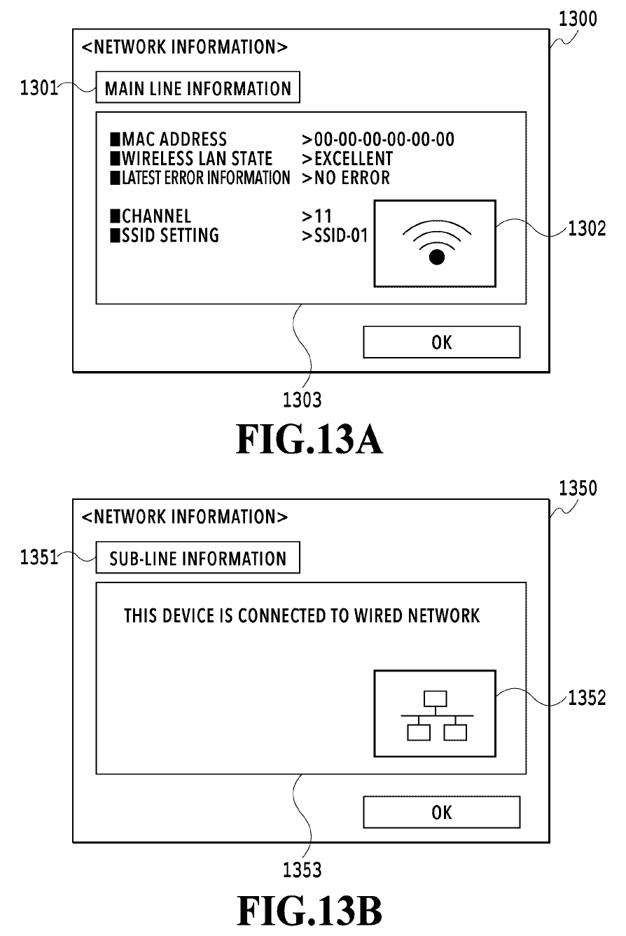

FIGS. 5A and 5B are diagrams illustrating examples of the setting screen. FIG. 5A is the network setting screen 500 displayed in the case where the pressing operation of the network button 405 in FIG. 4 is received. The user can check network related information relating to the networks, and change network related settings through the network setting screen 500. For example, in the case where pressing of a network information button 501 is received, the operation unit 113 transitions to a network information screen of one of FIGS. 11A, 11B, 13A, and 13B to be described later. The user can check pieces of information relating to the networks by checking the network information screen. Reception of pressing of an interface selection button 502 causes the operation unit 113 to transition to an interface selection screen 600 of FIG. 6 to be described later. In the interface selection screen 600, the user can input an instruction to set a combination of usage methods of the wired LAN and the wireless LAN.

Note that, in the various setting screens in the present embodiment, each of the buttons is configured to be pressable or not pressable by the user depending on the role of the login user. For example, the network setting screen 500 illustrated in FIG. 5A illustrates an example of the case where the login user is the administrator. The administrator can press various setting buttons. Meanwhile, for example, in the case where the login user is the regular user or the guest user, some of the buttons in the network setting screen 500 are displayed in a not-pressable manner. Specifically, the setting buttons of the interface selection button 502 and below are displayed in a grayed-out manner. The operation unit 113 is configured not to receive the pressing operations of the setting buttons displayed in a grayed-out manner even in the case where these setting buttons are pressed. Meanwhile, the network information button 501 is configured to be capable of receiving the pressing operation also in the case where the login user is the regular user or the guest user and in the case where login is not performed yet. In the present embodiment, the operation unit 113 is configured to display a screen that differs depending on the role of the login user also in the case where a pressing operation of the network information button 501 is received. Details are described later.

FIG. 5B is the setting screen 550 displayed in the case where the pressing operation of the setting button 406 in FIG. 4 is received. The user can change each of the settings of the MFP 101 through the setting screen 550. The setting screen 550 of FIG. 5B illustrates an example of the display screen in a state where the login is not performed. In the case where the login user is not the administrator and is, for example, the regular user, the guest user, or the not-logged-in user as described above, buttons other than a user setting button 552 are displayed in a grayed-out manner. In the case where the login user is the administrator, no grayed-out display is performed, and all buttons on the setting screen 550 are displayed to be capable of receiving pressing operations. The administrator can change settings relating to the entire device of the MFP 101 through a device setting button 551. All users can change settings applied only to the current login user (or the not-logged-in user) through the user setting button 552. The administrator can change settings relating to the networks of the MFP 101 through a network setting button 553. Moreover, the administrator can change a display setting of the network information specific to each of the users of the MFP 101 through a user-specific network display setting button 554.

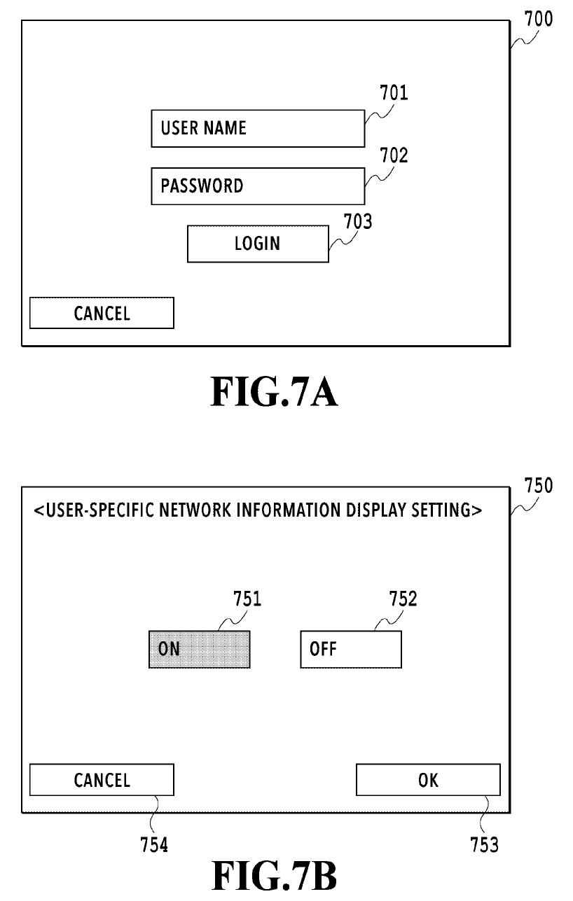

In the case where a pressing operation of a login button 555 is received, the operation unit 113 transitions to a login screen 700 of FIG. 7A to be described later. After execution of the login, the login button 555 switches to a button for logout. In the case where a pressing operation of the logout button is received, the operation unit 113 causes the currently-logged-in user to logout. After the logout, the login button 555 switches from the logout button to the login button 555. The operation unit 113 can receive the login operation again in the case where a pressing operation of this switched login button 555 is received. Note that, although the example in which the login button 555 is displayed on the setting screen 550 is explained in the present embodiment, the present disclosure is not limited to this example. For example, the configuration may be such that the login button 555 is displayed on the menu screen 400.

FIG. 6 is a diagram illustrating an example of the interface selection screen 600 displayed by the operation unit 113 in the case where the pressing operation of the interface selection button 502 on the network setting screen 500 of FIG. 5A is received. As described above, the interface selection screen 600 is a screen displayed in the case where the login user is the administrator. In the interface selection screen 600, the administrator can determine a combination of the main line and the sub-line in the case where the wired LAN and the wireless LAN are used for the MFP 101, and change the settings. The main line is a main network line generally used in normal operations, and is a line set by the administrator under assumption that the line is to be mainly used by the regular user and the like. Meanwhile, the sub-line is a sub-line that is generally, secondarily used. The sub-line is a line used, for example, in the case where the guest user logs in. Alternatively, the sub-line is a subsidiary line used for data exchange in the case where information on other services provided by a manufacturer such as a remote diagnosis tool is exchanged. The sub-line generally has a functional restriction such as usable functions are fewer than those of the main line in some cases.

A setting method in the interface selection screen 600 is explained. For example, in the case where the user (administrator) presses a wired LAN button 601, the wired LAN button 601 goes into a selected state. In the case where the wired LAN button 601 goes into the selected state, for example, the operation unit 113 performs feedback expression that allows the user to recognize that the button is selected and is enabled such as changing of the color of the button or adding of a check mark. Reception of a pressing operation of an OK button 604 in the state where the wired LAN button 601 is selected causes this setting value to be stored in the HDD 205 as data. Storing the setting value changes the setting such that the wired LAN is set as the main line on the network of the MFP 101. Similarly, reception of the pressing operation of the OK button 604 in a state where a pressing operation of a wireless LAN button 602 is received and the wireless LAN button 602 is selected causes the wireless LAN to be set as the main line on the network of the MFP 101. Moreover, reception of the pressing operation of the OK button 604 in a state where a wireless LAN+wired LAN button 603 is selected causes the wireless LAN to be set as the main line and causes the wired LAN to be set as the sub-line on the network of the MFP 101. In the case where a pressing operation of a cancel button 605 is received on the interface selection screen 600, the change of the setting value is not saved, and the operation unit 113 closes the interface selection screen 600.

Note that any setting may be configured to be enabled as an initial value. In the present embodiment, it is assumed that, before the administrator performs the selection on the interface selection screen 600, the wired LAN is set as the main line.

The buttons of the respective setting values such as the wired LAN button 601, the wireless LAN button 602, and the wireless LAN+wired LAN button 603 displayed on the interface selection screen 600 may not be displayed in the case where the MFP 101 does not have effective hardware configurations. Alternatively, these buttons may be displayed in a grayed-out manner. There may be adopted a form in which control is performed such that setting of ineffective setting values is disabled in the case where the MFP 101 does not have the effective hardware configurations as described above. In the case where the MFP 101 checks whether the MFP 101 has the wireless LAN function or the wired LAN function, the MFP 101 can perform determination by checking the network I/F 206 and checking whether the wireless LAN device 208 or the wired LAN device 207 is functioning.

Note that, although an example of the combination of network interfaces in which setting of a combination of two or less lines can be performed on the interface selection screen 600 illustrated in FIG. 6 is explained for the sake of convenience, the present disclosure is not limited to this. The number of lines usable in the information processing apparatus may increase. The number of lines is not limited to two, and may be three, four, or more, and it is only necessary that the interface selection screen 600 is a setting screen corresponding to a combination of multiple lines.

FIGS. 7A and 7B are diagrams illustrating examples of screens. FIG. 7A is the login screen 700 displayed by the operation unit 113 in the case where the pressing operation of the login button 555 in FIG. 5B is received. On the login screen 700, the user inputs a user name into a user name input area 701, inputs a password into a password input area 702, and presses a login button 703. In the case where the MFP 101 receives such input operations, the MFP 101 executes a login process with a specific user account associated with the inputted user name and the inputted password. Note that the login screen 700 can be set as a screen to be displayed first depending on the settings of the MFP 101. In this case, the login screen 700 can be displayed before display of the menu screen 400. The user account includes a setting value referred to as role. The setting value of the role has categories of administrator, regular user, and guest user. The administrator can access and edit all pieces of information and all settings of the MFP 101. Access and editing privileges of the regular user are partially limited. The guest user is a user whose privileges are further restricted than the regular user, and is a user whose usable functions are restricted such as, for example, use of printing with a guest code. Moreover, a category of not-logged-in user who has not logged in is provided separately from the setting values of the roles or as one of the setting values of the roles.

FIG. 7B is a user-specific network information display setting screen 750. FIG. 7B is a screen displayed in the case where the user-specific network display setting button 554 in FIG. 5B is pressed by the administrator. On the user-specific network information display setting screen 750, the administrator can set whether to turn ON or OFF the setting of changing the display of the network information depending on the login user. In the case where an OK button 753 is pressed in a state where an ON button 751 is selected, a setting value of a user-specific network information display setting is set to ON. In the case where the OK button 753 is pressed in a state where an OFF button 752 is selected, the setting value of the user-specific network information display setting is set to OFF. In the case where the setting is changed, the setting value is written and saved in the HDD 205. In the case where the setting value of the user-specific network information display setting is ON, the network information to be displayed is made to differ based on the role of the login user. Details are described later. Meanwhile, in the case where the setting value of the user-specific network information display setting is OFF, the network information corresponding to the setting content set on the interface selection screen 600 is commonly displayed to all users. The network information is information on the icon displayed in the network button 405 of FIG. 4 and information displayed in the case where the network information button 501 of FIG. 5A is pressed in the example of the present embodiment. Note that the network information may be one of the information on the icon displayed in the network button 405 of FIG. 4 and the information displayed in the case where the network information button 501 of FIG. 5A is pressed. Moreover, the network information is not limited to the above-mentioned pieces of information, and may be other pieces of information relating to the network. In the case where a cancel button 754 is pressed in FIG. 7B, the screen returns to the previous screen without the change of the setting.

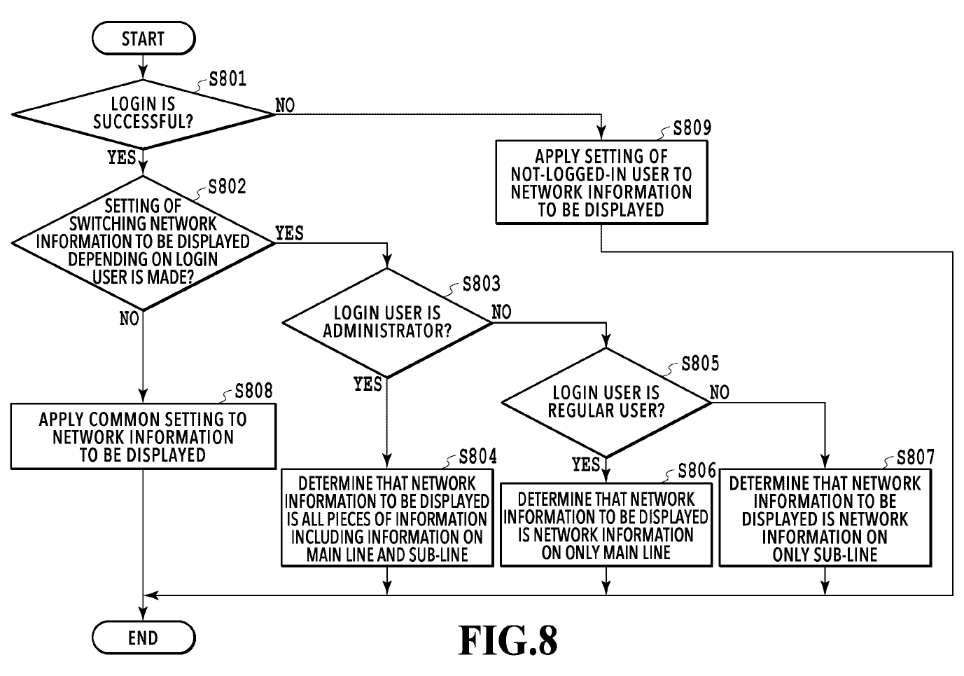

FIG. 8 is a flowchart illustrating an example of a process of determining the network information to be displayed in the present embodiment. The CPU 201 of the MFP 101 implements the flowchart of FIG. 8 by reading a program stored in the HDD 205 or the like out to the DRAM 202 and executing the program. Note that all or part of functions in the steps in FIG. 8 may be implemented by hardware such as an ASIC or an electronic circuit. The sign "S" in explanation of each process means step in the flowchart (the same applies below to the other flowcharts in the present specification). The process of the flowchart illustrated in FIG. 8 is started based on reception of a pressing operation of the login button 703 on the login screen 700. Note that explanation is given assuming that the MFP 101 is in a state where the wireless LAN is set as the main line and the wired LAN is set as the sub-line on the interface selection screen 600 for the sake of convenience.

In S801, the CPU 201 determines whether the login is successful. If the login is successful, the CPU 201 proceeds to S802. If the login fails, the CPU 201 proceeds to S809.

In S802, the CPU 201 determines whether the setting of switching the network information to be displayed depending on the login user is made. The determination of S802 is performed based on the setting value of the user-specific network information display setting screen 750. If the setting value of the user-specific network information display setting screen 750 is ON, the CPU 201 determines that the setting of switching the network information to be displayed is made, and proceeds to S803. If the setting value of the user-specific network information display setting screen 750 is OFF, the CPU 201 determines that the setting of switching the network information to be displayed is not made, and proceeds to S808.

In S803, the CPU 201 determines whether the login user is the administrator. If the CPU 201 determines that the login user is the administrator, the CPU 201 proceeds to S804. If the CPU 201 determines that the login user is not the administrator, the CPU 201 proceeds to S805. Note that the CPU 201 determines whether the login user is the administrator, the regular user, or the guest user based on user information managed by the MFP 101. Specifically, the CPU 201 obtains the user information of the login user, and determines whether the login user is the administrator, the regular user, or the guest user based on the obtained user information. In S804, the CPU 201 determines that the network information to be displayed is all pieces of information including the information on the main line and the information on the sub-line. Then, the CPU 201 terminates the process of the flowchart illustrated in FIG. 8.

In S805, the CPU 201 determines whether the login user is the regular user. If the CPU 201 determines that the login user is the regular user, the CPU 201 proceeds to S806. If the CPU 201 determines that the login user is not the regular user, the CPU 201 proceeds to S807. In S806, the CPU 201 determines that the network information to be displayed is information on only the main line. Then, the CPU 201 terminates the process of the flowchart illustrated in FIG. 8. In S807, the CPU 201 determines that the network information to be displayed is information on only the sub-line. Then, the CPU 201 terminates the process of the flowchart illustrated in FIG. 8.

Explanation is given of a process in the case where the setting of switching the network information to be displayed depending on the login user is not made. In S808, the CPU 201 determines to apply a common setting to the network information to be displayed irrespective of the role of the login user. Specifically, the CPU 201 determines to apply the setting in the interface selection screen 600 to the network information to be displayed. Then, the CPU 201 terminates the process of the flowchart illustrated in FIG. 8.

A process in the case where the login fails is explained. In S809, the CPU 201 applies a setting for the not-logged-in user to the network information to be displayed. The setting for the not-logged-in user may be any setting. For example, the same setting as that for the guest user or a setting in which no network information is displayed may be applied to the network information of the not-logged-in user, or a separate setting for the not-logged-in user may be provided. For example, the network information may include real-time information such as the radio field intensity to be described later. The following setting or the like may be adopted as the separate setting for the not-logged-in user: general display indicating that the network information is information relating to the network is performed, but the above-mentioned real-time information is not displayed. Then, the CPU 201 terminates the process of the flowchart illustrated in FIG. 8. Note that the setting for the not-logged-in user may be set as the setting of the network information to be displayed by default before start of the process of the flowchart illustrated in FIG. 8, that is before reception of the pressing operation of the login button 703.

The CPU 201 displays the network information based on the contents determined as described above. As described above, the network information in the present embodiment is the information on the icon displayed in the network button 405 of FIG. 4 and the information displayed in the case where the network information button 501 of FIG. 5A is pressed. Explanation is given below by using the case of the network button 405 as an example.

In the present embodiment, in the case where the network information to be displayed is determined to be all pieces of information including the information on the main line and the information on the sub-line in S804, the operation unit 113 displays the network button 405 as illustrated in FIG. 4 in displaying of the menu screen 400 illustrated in FIG. 4. The network button 405 illustrated in FIG. 4 is a diagram of an example of a display mode in which the information on the main line and the information on the sub-line are simultaneously displayed on the icon in the configuration in which the main line is the wireless LAN and the sub-line is the wired LAN. Moreover, in the case where the link to the network setting screen 500 is set in the shortcut button 407, an icon equivalent to the network button 405 may be displayed also in the shortcut button 407. The same icon as the network button 405 is displayed in the shortcut button 407 of FIG. 4. The reason of adopting the display mode as described above is such that displaying all pieces of information is effective in terms of management for the administrator. Note that, in the configuration in which there is no sub-line, only the information (icon) on the main line is displayed even in the case where the network information to be displayed is determined to be all pieces of information including the information on the main line and the information on the sub-line in S804. This is because there is no need to display the information on the sub-line in the case where there is no sub-line. Similarly, also in the case where the setting of only the main line is selected on the interface selection screen 600 of FIG. 6, that is, for example, the case where the wired LAN button 601 is selected and set, only the information on the main line is displayed even if the determination of S804 is made.

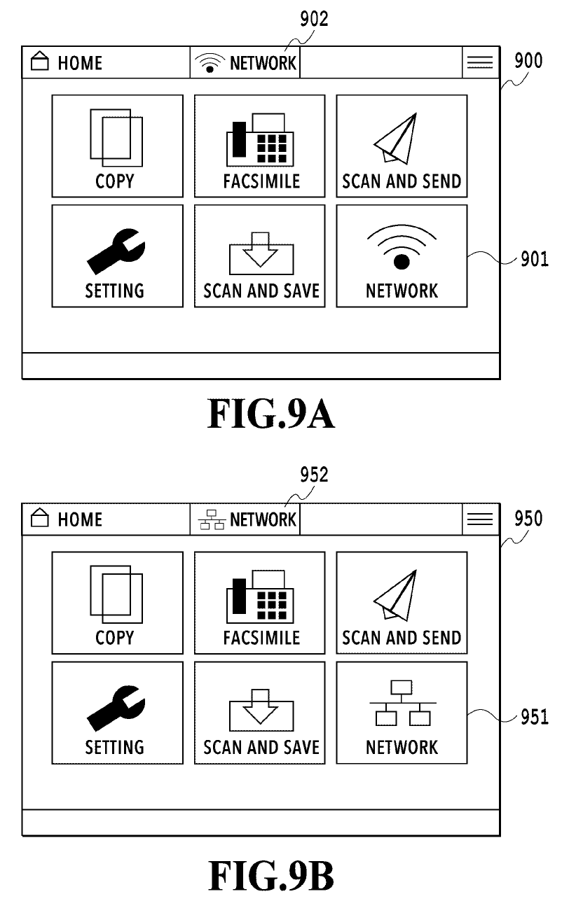

In the case where the network information to be displayed is determined to be the information on only the main line in S806, the operation unit 113 displays a network button 901 as illustrated in FIG. 9A in displaying of the menu screen 400 as illustrated in FIG. 4.

FIGS. 9A and 9B are diagrams illustrating examples of the menu screen. FIG. 9A is a diagram illustrating an example of a menu screen 900 displayed in the case where the network information to be displayed is determined to be the information on only the main line in S806. The network button 901 illustrated in FIG. 9A is a diagram of an example of a display mode in which the information on the wireless LAN that is the main line is displayed on the icon in the configuration in which the main line is the wireless LAN and the sub-line is the wired LAN. Moreover, in the case where the link to the network setting screen 500 is set in a shortcut button 902, an icon equivalent to the network button 901 may be displayed also in the shortcut button 902. The same icon as the network button 901 is displayed in the shortcut button 902 of FIG. 9A. The reason of adopting the display mode as described above is such that displaying only the information on the main line basically used by the regular user is effective in improving usability for the regular user. Specifically, since the regular user basically does not use the sub-line, the regular user does not have to pay attention to the sub-line. Accordingly, reducing the information by not displaying the information unnecessary to the regular user as illustrated in FIG. 9A can improve a degree of understanding of the screen by the regular user.

In S807, in the case where the network information to be displayed is determined to be the information on only the sub-line, the operation unit 113 displays a network button 951 as illustrated in FIG. 9B in displaying of the menu screen 400 as illustrated in FIG. 4.

FIG. 9B is a diagram illustrating an example of a menu screen 950 displayed in the case where the network information to be displayed is determined to be the information on only the sub-line in S807. The network button 951 illustrated in FIG. 9B is a diagram of an example of a display mode in which the information on the wired LAN that is the sub-line is displayed on the icon in the configuration in which the main line is the wireless LAN and the sub-line is the wired LAN. Moreover, in the case where the link to the network setting screen 500 is set in a shortcut button 952, an icon equivalent to the network button 951 may be displayed also in the shortcut button 952. The same icon as the network button 951 is displayed in the shortcut button 952 of FIG. 9B. The reason of adopting the display mode as described above is such that displaying only the information on the sub-line used by the guest user is sufficient for the guest user. Note that in the case where there is no sub-line or the sub-line is not set, the operation unit 113 displays the information on the main line also for the guest user. This is because, in the case where there is no sub-line or the sub-line is not set, the users of all roles use the main line.

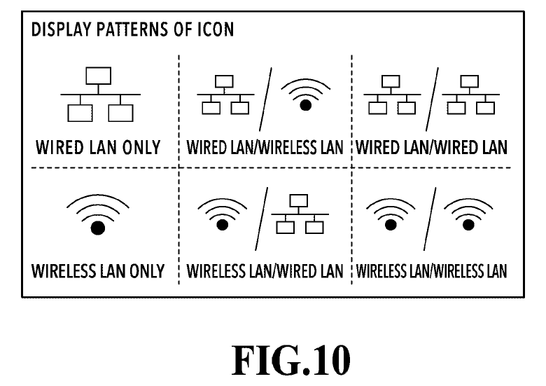

FIG. 10 is a diagram illustrating examples of a pattern of the icon displayed in FIGS. 4, 9A, and 9B. The configuration may be such that the wired LAN is used as the main line and the wireless LAN is used as the sub-line or such that the wireless LAN is used as both of the main line and the sub-line. In this case, the network button and the like may be displayed in display modes of the icon as illustrated in FIG. 10. Note that designs illustrated in FIG. 10 are examples, and the present disclosure is not limited to these examples. Moreover, in a configuration provided with three or more lines and provided with multiple sub-lines, the display modes may be modes in which the other sub-lines are further displayed. In the example of FIG. 10, it is assumed that, in the case where the configuration includes the main line and the sub-line, the line whose name is displayed first is the main line, and the line whose name is displayed later is the sub-line. Specifically, the icon in which "wireless LAN/wired LAN" is displayed means that the wireless LAN is the main line and the wired LAN is the sub-line. Note that this is merely an example, and the display positions of the main line and the sub-line may be reversed, or the names may be displayed one on top of the other or in other arrangements instead of side by side.

Next, explanation is given by using the information displayed in the case where the network information button 501 of FIG. 5A is pressed as an example of the network information whose display mode is made to differ.

FIGS. 11A and 11B are diagrams illustrating examples of the network information screen. FIG. 11A illustrates an example of a network information screen 1100 in which the login user is the administrator and that displays the main line information. The network information screen 1100 is a screen displayed by the operation unit 113 in the case where the pressing operation of the network information button 501 in FIG. 5A is received. Note that, as described above, the network information button 501 is configured such that the user of any role can perform the pressing operation thereof.

In the present embodiment, if the pressing operation of the network information button 501 in FIG. 5A is received after S804 in the case where the login user is the administrator, the operation unit 113 displays the network information screen 1100 illustrated in FIG. 11A. A main line information tab 1101 and a sub-line information tab 1102 are displayed on the network information screen 1100. In the network information screen 1100, the main line information tab 1101 is in a selected state. Reception of a pressing operation of each of these tabs causes the operation unit 113 to make contents displayed in an information display area 1104 to differ based on contents of the selected tab. Specifically, information on the selected line is displayed in the information display area 1104. Moreover, the contents displayed in the information display area 1104 are made to differ depending on the role of the login user. The network information screen of FIG. 11A is a screen example displayed in the case where the login user is the administrator. Since the administrator is logged in, pieces of information such as a security setting that is information on security and a power saving mode that is a setting changeable only by the administrator are displayed in the information display area 1104. An icon 1103 is in a display mode indicating a line corresponding to the selected tab. Specifically, in the present example, since the main line is the wireless LAN and the main line information tab 1101 is in the selected state, the information on the wireless LAN is displayed in the icon 1103. To be more specific, the icon 1103 may be in a display mode based on the current radio field intensity of the wireless LAN.

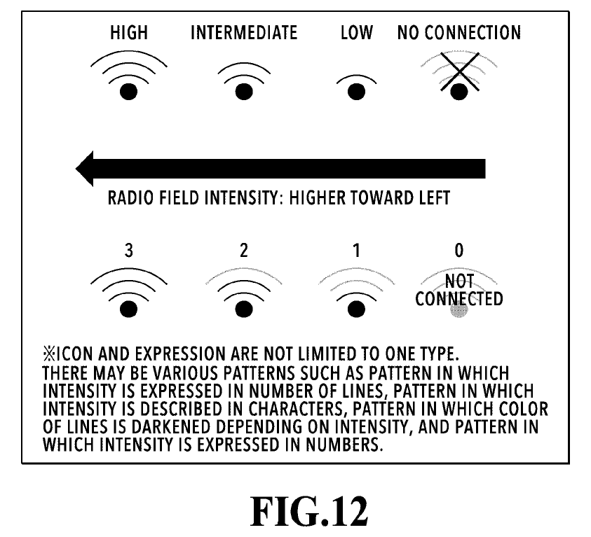

FIG. 12 is a diagram explaining an example in which the display mode that differs depending on the radio field intensity is illustrated as an icon. As illustrated in FIG. 12, the icon and the expression are not limited to one type. For example, the display mode may be a mode in which the radio field intensity is expressed in the number of lines, a mode in which the radio field intensity is described in characters, a mode in which the number of lines whose color is darkened is changed depending on the radio field intensity, or a mode in which the radio field intensity is expressed in numbers. Moreover, there may be adopted various display modes such as a mode in which a disconnected state is expressed in words such as "no connection" or "not connected" or a mode in which an x (cross) mark is displayed to indicate the disconnected state. Furthermore, although FIG. 12 illustrates the examples of the display mode of the icon in the case of the wireless LAN, a similar display mode may be adopted also for the case of the wired LAN. For example, there may be adopted a display mode such as a mode in which character information such as "no connection" or "not connected" is displayed in the case where the wired LAN is not in the connected state or a mode in which an x (cross) mark is displayed to indicate the disconnected state. Moreover, the display mode depending on the network status as described above can be applied also to the icon and the like displayed on the menu screen and the like explained in FIG. 4 and the like.

FIG. 11B illustrates an example of the network information screen 1100 in which the login user is the administrator and that displays the sub-line information. Specifically, FIG. 11B illustrates a screen in the case where the sub-line information tab 1102 is selected. Information on the wired network is displayed in an information display area 1154. An icon indicating the network status of the wired LAN is displayed in an icon 1153.

In the case where the login user is the administrator as described above, the setting screen of each of the multiple networks can be displayed, and all setting values in the setting screen of each of the networks can be displayed.

FIGS. 13A and 13B are diagrams illustrating examples of the network information screen. FIG. 13A illustrates an example of a network information screen 1300 in the case where the login user is the regular user. In the present embodiment, if the operation unit 113 receives the pressing operation of the network information button 501 in FIG. 5A after S806 in the case where the login user is the regular user, the operation unit 113 displays the network information screen 1300 illustrated in FIG. 13A. A main line information tab 1301 is displayed on the network information screen 1300. No sub-line information tab illustrated in FIGS. 11A or 11B is displayed on the network information screen 1300. Accordingly, the network information screen 1300 is configured such that contents displayed in an information display area 1303 cannot be switched. The contents displayed in the information display area 1303 are contents relating to the main line. Moreover, the contents displayed in the information display area 1303 are display contents corresponding to the regular user. Specifically, pieces of information such as the security setting that is the information on security and the power saving mode that is the setting changeable only by the administrator are not displayed unlike the case where the administrator is logged in. An icon 1302 is in the display mode indicating the radio field intensity like the icon 1103 explained in FIG. 11A.

FIG. 13B illustrates an example of a network information screen 1350 in the case where the login user is the guest user. In the present embodiment, if the operation unit 113 receives the pressing operation of the network information button 501 in FIG. 5A after S807 in the case where the login user is the guest user, the operation unit 113 displays the network information screen 1350 illustrated in FIG. 13B. A sub-line information tab 1351 is displayed on the network information screen 1350. No main line information tab illustrated in FIGS. 11A or 11B is displayed on the network information screen 1350. Accordingly, the network information screen 1350 is configured such that contents displayed in an information display area 1353 cannot be switched. The contents displayed in the information display area 1353 are information relating to the sub-line. Moreover, the contents displayed in the information display area 1353 are display contents corresponding to the guest user. Note that, in the present example, the contents displayed in the case of the wired LAN are contents common to the roles. Accordingly, the contents displayed in the information display area 1353 including an icon 1352 are similar to the contents displayed in the information display area 1154 of FIG. 11B.

In the case where the login user is the regular user or the guest user as described above, it is possible to display the setting screen of one of the multiple networks and display some of the setting values in the setting screen of this network.

Note that, although explanation is given of the example in which the tab of information indicating whether the network line is the main line or the sub-line like the main line information tab and the sub-line information tab is displayed in the examples of FIGS. 13A and 13B, the present disclosure is not limited to these examples. The information indicating the type of line such as the main line and the sub-line does not have to be displayed to the users of the roles who cannot switch the line. This is due to the following reason: the information which the login user cannot switch by himself/herself is not displayed to prevent unnecessary information from being given to the login user.

Moreover, although explanation is given of the example in which the information displayed in the display region is switched between the information on the main line and the information on the sub-line by using the tabs in the examples of FIGS. 11A and 11B, the present disclosure is not limited to this example. A mode in which the information on the main line and the information on the sub-line are displayed together in the same display region may be adopted.

As explained above, according to the present embodiment, the usability can be improved in a configuration of multiple networks. Specifically, in the present embodiment, control is performed such that display of the connection information of the multiple networks is made to differ depending on the role of the user logged in the information processing apparatus. For example, in the case where information indicating the role of the user is first user information, the information on the multiple networks is displayed in a first mode. Meanwhile, in the case where the information indicating the role of the user is second user information different from the first user information, the information on the multiple networks is displayed in a second mode different from the first mode. This enables information display that includes no useless information and that is easily understandable to the logged-in user.

### Second Embodiment

In the first embodiment, explanation is given of the example in which the network information to be displayed is switched based on the role of each login user determined in advance, according to the process of the flowchart illustrated in FIG. 8. In the present embodiment, explanation is given of an example in which the administrator can set the network information to be displayed for each role. Note that, since a basic configuration and the like are similar to those in the example explained in the first embodiment, explanation thereof is omitted, and differences from the first embodiment are mainly explained below.

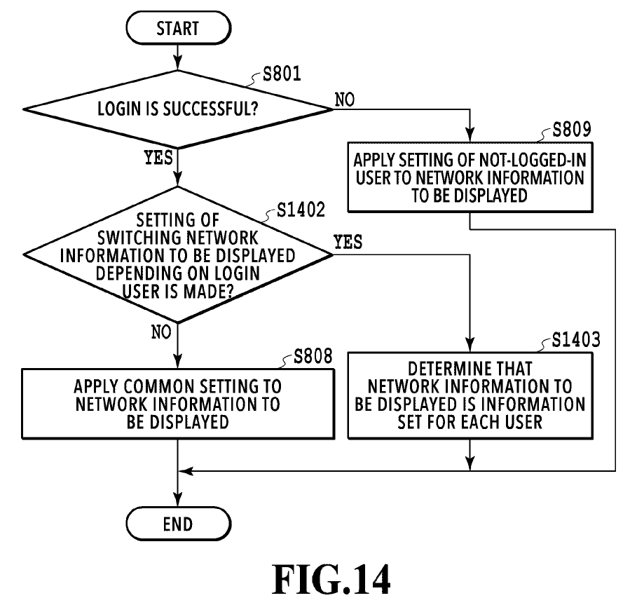

FIG. 14 is a flowchart illustrating an example of a process of determining the network information to be displayed in the present embodiment. As in the example explained in FIG. 8, the CPU 201 of the MFP 101 implements the flowchart of FIG. 14 by reading a program stored in the HDD 205 and the like out to the DRAM 202 and executing the program. The process of the flowchart illustrated in FIG. 14 is started based on reception of the pressing operation of the login button 703 on the login screen 700. Note that explanation is given assuming that the MFP 101 is in a state where the wireless LAN is set as the main line and the wired LAN is set as the sub-line on the interface selection screen 600 also in the present example for the sake of convenience.

In FIG. 14, processes equivalent to those in FIG. 8 are denoted by signs identical to those in FIG. 8, and explanation thereof is omitted. S1402 is a process similar to S802. In the present embodiment, in the case where the CPU 201 determines that the setting of switching the network information to be displayed depending on the login user is made in S1402, the process proceeds to S1403. In S1403, the CPU 201 determines that the network information to be displayed is information set for each user. Then, the CPU 201 terminates the process of the flowchart illustrated in FIG. 14. Specifically, the process of FIG. 14 is a process in which the processes from S803 to S807 in FIG. 8 are replaced by the process of S1403. Other processes are similar to the processes illustrated in FIG. 8.

In the case where the menu screen 400 of FIG. 4 is displayed after the process of the flowchart of FIG. 14, the information on the icon displayed in the network button 405 is information based on the information determined in the process of FIG. 14. Similarly, in the case where the pressing operation of the network information button 501 in FIG. 5A is received after the process of the flowchart of FIG. 14, information based on the information determined in the process of FIG. 14 is displayed. Note that, as explained in the first embodiment, these pieces of information are also information based on the interface selection screen 600. For example, in the case where only the main line is selected on the interface selection screen 600, information on only the main line is displayed even in the case where display of the main line and the sub-line is determined as a result of the process of FIG. 14. This point is the same as explained in the first embodiment.

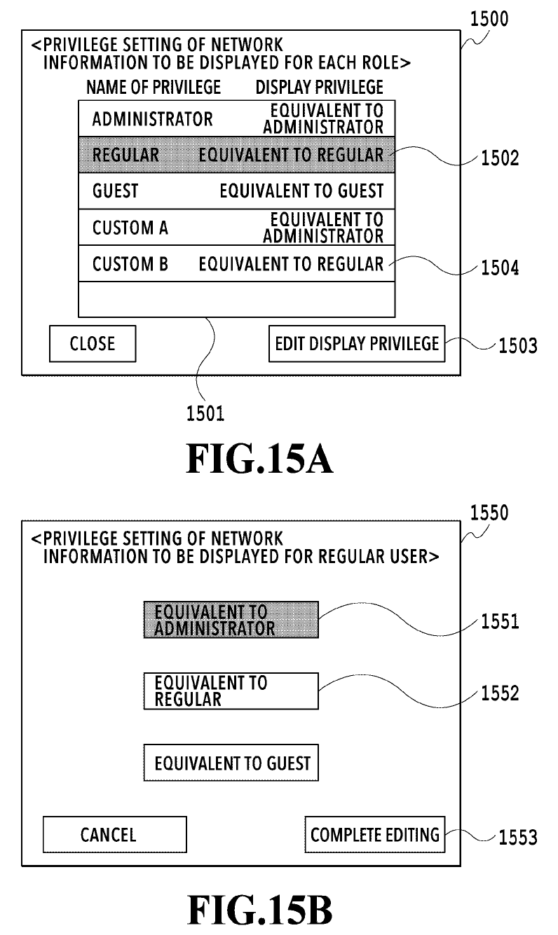

FIGS. 15A and 15B are diagrams illustrating examples of a screen in which privileges of the network information are set. FIG. 15A illustrates a privilege setting screen 1500 of the network information to be displayed for each role. The privilege setting screen 1500 is, for example, a screen as follows. A button (not illustrated) for transition to the privilege setting screen 1500 is provided on the setting screen 550 of FIG. 5B, the privilege setting screen 1500 is displayed in the case where pressing of this button is received. Note that the button (not illustrated) for transition to the privilege setting screen 1500 may be configured to be capable of receiving the pressing operation in the case where the login user is the administrator. Accordingly, the button (not illustrated) for transition to the privilege setting screen 1500 is configured not to receive the pressing operation, for example, configured to be displayed in a grayed-out manner for users of roles other than the administrator.

The privilege setting screen 1500 includes a setting display area 1501 in which names of privileges such as administrator, regular user, guest user, and custom roles and privileges associated with the respective names are displayed. On the privilege setting screen 1500, setting contents in which "administrator, equivalent to administrator" is displayed in the first row means that the administrator has a privilege equivalent to a default privilege of the administrator. Specifically, this setting contents means that the administrator has a privilege of browsing both of the information on the main line and the information on the sub-line. Note that, although explanation is given by using an example in which a default privilege of each role is similar to the corresponding privilege explained in the first embodiment also in the present embodiment, the default privilege is merely an example, and is not limited to this example. Similarly, a privilege equivalent to the regular user is a privilege of browsing the information on the main line. A privilege equivalent to the guest user is a privilege of browsing the information on the sub-line.

Each of the rows in the setting display area 1501 is a button. For example, in the case where a pressing operation of a button 1502 in which "regular, equivalent to regular" is displayed in the second row is received, this row goes into a selected state. In the case where a pressing operation of an edit display privilege button 1503 is received in the state where the button 1502 is selected, the operation unit 113 transitions to an individual privilege setting screen 1550 illustrated in FIG. 15B. Note that, in the case where the pressing operation of the edit display privilege button 1503 is received in a state where a button of another row is selected, an individual privilege setting screen for a user of the corresponding role is similarly displayed.

FIG. 15B is a diagram illustrating the individual privilege setting screen 1550 of the network information to be displayed for the regular user. On the individual privilege setting screen 1550 of FIG. 15B, the administrator can set and change the privilege of the network information to be displayed for the regular user to the same levels as those for the other roles. In the case where the screen transitions from the privilege setting screen 1500 of FIG. 15A to the individual privilege setting screen 1550 of FIG. 15B as described above, a setting value 1552 of "equivalent to regular user" is in a selected state on the individual privilege setting screen 1550. FIG. 15B illustrates a state where a setting value 1551 of "equivalent to administrator" is then selected by the administrator. In the case where a pressing operation of an edit complete button 1553 is received in this state, the setting value of the privilege of the network information to be displayed for the regular user is changed to "equivalent to administrator". The changed setting value is written and saved in the HDD 205. Moreover, the screen displayed in the operation unit 113 also returns to the privilege setting screen 1500 of FIG. 15A. On the privilege setting screen 1500 in this case, display of the button 1502 in which "regular, equivalent to regular user" has been displayed is changed to "regular, equivalent to administrator".

Moreover, the roles of the present embodiment include a role referred to as custom role. The custom role is a role having default setting values and a default privilege based on the role of the administrator, the regular user, or the guest user, and is a role for which the setting values can be customized in further detail.

For example, a button 1504 of "custom B, equivalent to regular" on the individual privilege setting screen 1550 of FIG. 15A is a custom role created based on the regular user. In the case where the custom role "custom B" is based on the regular user, "custom B" has setting values and a privilege equivalent to those of the regular user. For example, in the case where the regular user is prohibited from performing color printing and is allowed to perform color scanning, "custom B" is created as a custom role based on the regular user. Then, settings of "custom B" can be further changed in detail to such settings that the color printing is allowed and the color scanning is allowed. Multiple custom roles can be created, and the administrator who creates the custom roles can assign any names to these custom roles such as "custom A", "custom B", and "special user". FIG. 15A illustrates a screen in a state where two users of "custom A" and "custom B" are created. On the individual privilege setting screen 1550, the privilege of the network information can be set as described above also for the users of the above-mentioned custom roles. Specifically, the configuration is such that the privilege of the network information for each of the two custom roles of the role of "custom A" and the role of "custom B" can be set on the individual privilege setting screen 1550.

Note that the configuration is such that the settings illustrated in FIGS. 15A and 15B cannot be selected in the case where the setting value indicating that the MFP 101 is provided with only the main line such as "only wired LAN" or "only wireless LAN" is selected on the interface selection screen 600 as explained in the first embodiment. For example, the configuration may be such that the button for transition to the privilege setting screen 1500 is displayed in a grayed-out manner, or although transition to the privilege setting screen 1500 is possible, the setting display area 1501 and the edit display privilege button 1503 are displayed in a grayed-out manner. This is because, in the configuration in which the MFP 101 is provided with only the main line, the administrator does not have to set how to display the network information on the main line and the sub-line.

As explained above, in the present embodiment, the administrator can set the privilege of the network information to be displayed depending on the role as desired. Since this allows the privilege to be flexibly set depending on an organization, the usability can be further improved. Moreover, since the administrator can set the privilege of the network information to be displayed as desired also for the user of the customized role such as the custom role, more flexible privilege setting is possible.

### Third Embodiment

The present embodiment is also an embodiment in which the process based on the flowchart of FIG. 14 is performed like the second embodiment. Since a basic configuration is similar to that in the example explained in the first embodiment and explanation of the flowchart of FIG. 14 is similar to that in the example explained in the second embodiment, explanation thereof is omitted. Differences from the first embodiment and the second embodiment are mainly explained below.

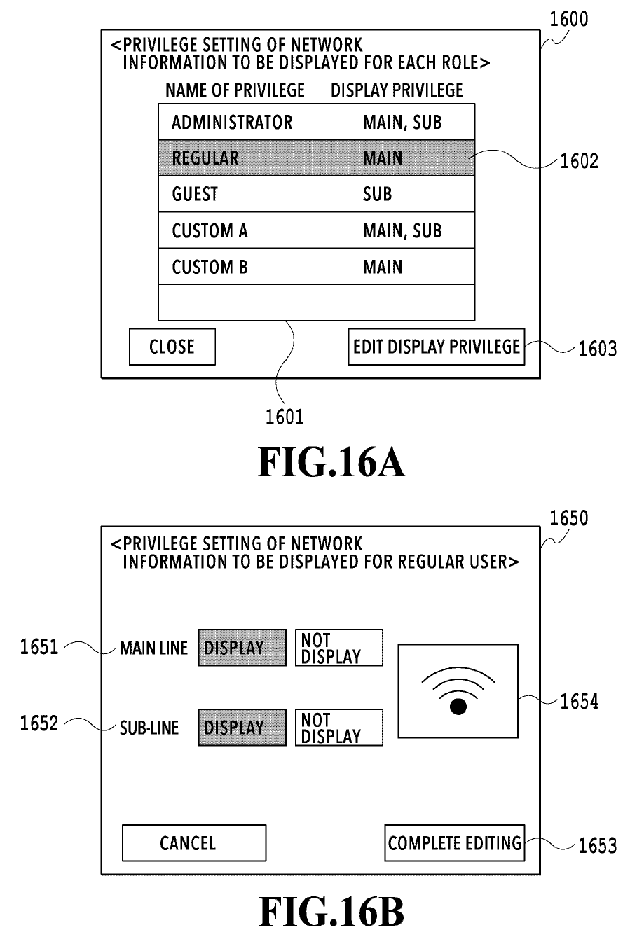

FIGS. 16A and 16B are diagrams illustrating examples of the screen in which the privileges of the network information are set. FIG. 16A illustrates a privilege setting screen 1600 of the network information to be displayed for each role. The privilege setting screen 1600 is, for example, a screen as follows. A button (not illustrated) for transition to the privilege setting screen 1600 is provided on the setting screen 550 of FIG. 5B, and the privilege setting screen 1600 is displayed in the case where pressing of this button is received. Note that the button (not illustrated) for transition to the privilege setting screen 1600 may be configured to be capable of receiving the pressing operation in the case where the login user is the administrator. Accordingly, the button (not illustrated) for transition to the privilege setting screen 1600 is configured not to receive the pressing operation, for example, configured to be displayed in a grayed-out manner for users of roles other than the administrator.

In the present embodiment, in the case where an interface with multiple lines is selected on the interface selection screen 600, the operation unit 113 displays the privilege setting screen 1600 as illustrated in FIG. 16A. For example, in the case where the setting value of "wired LAN+wired LAN" or "wireless LAN+wired LAN" is selected on the interface selection screen 600, the privilege setting screen 1600 as illustrated in FIG. 16A is displayed. The privilege setting screen 1600 includes a setting display area 1601 in which names of privileges such as administrator, regular, guest, and custom roles and privileges associated with the respective names are displayed.

On the privilege setting screen 1600, setting contents in which "administrator, main, sub" is displayed in the first row means that the administrator has a privilege of browsing the information on the main line and the sub-line. Similarly, the regular user has a privilege of browsing the information on the main line by default. The guest user has a privilege of browsing the information on the sub-line by default.

Each of the rows in the setting display area 1601 is a button. For example, in the case where a pressing operation of a button 1602 in which "regular, main" is displayed in the second row is received, this row goes into a selected state. In the case where a pressing operation of an edit display privilege button 1603 is received in the state where the button 1602 is selected, the operation unit 113 transitions to an individual privilege setting screen 1650 illustrated in FIG. 16B. Note that, in the case where the pressing operation of the edit display privilege button 1603 is received in a state where a button of another row is selected, an individual privilege setting screen for a user of the corresponding role is similarly displayed.

FIG. 16B is a diagram illustrating the individual privilege setting screen 1650 of the network information to be displayed for the regular user. On the individual privilege setting screen 1650 of FIG. 16B, the administrator can set and change the privilege of the network information to be displayed for the regular user to display or not-display for each of the main line and the sub-line. In the case where the screen transitions from the privilege setting screen 1600 of FIG. 16A to the individual privilege setting screen 1650 of FIG. 16B as described above, a setting value 1651 of the main line is in a state where "display" is selected on the individual privilege setting screen 1650. Meanwhile, a setting value 1652 of the sub-line is in a state where "not display" is selected. FIG. 16B illustrates a state where selection of changing the setting value 1652 of the sub-line from "not display" to "display" is then performed by the administrator. In the case where a pressing operation of an edit complete button 1653 is received in this state, the setting values of the privilege of the network information to be displayed for the regular user are changed to "display" for both of the main line and the sub-line. The changed setting values are written and saved in the HDD 205. Moreover, the screen displayed in the operation unit 113 also returns to the privilege setting screen 1600 of FIG. 16A. On the privilege setting screen 1600 in this case, display of the button 1602 in which "regular, main" has been displayed is changed to "regular, main, sub". Note that, although the example in which an icon 1654 indicating the radio field intensity is also displayed is illustrated in FIG. 16B, the icon 1654 does not have to be displayed.

Note that the configuration is such that the settings illustrated in FIGS. 16A and 16B cannot be selected in the case where the setting value indicating that the MFP 101 is provided with only the main line such as "only wired LAN" or "only wireless LAN" is selected on the interface selection screen 600. For example, the configuration may be such that the button for transition to the privilege setting screen 1600 is displayed in a grayed-out manner, or although transition to the privilege setting screen 1600 is possible, the setting display area 1601 and the edit display privilege button 1603 are displayed in a grayed-out manner. This is because, in the configuration provided with only the main line, the administrator does not have to set how to display the network information on the main line and the sub-line.

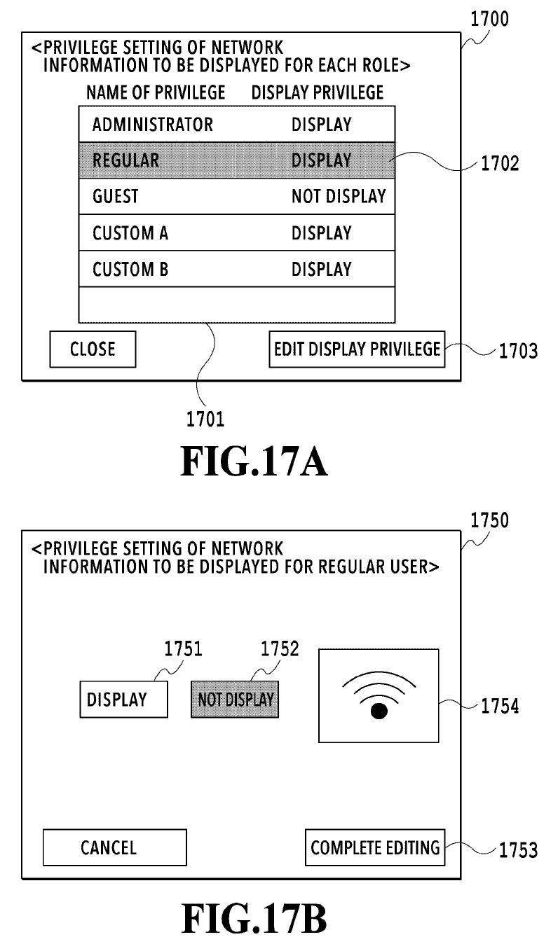

FIGS. 17A and 17B are diagrams illustrating other examples of the screen in which the privileges of the network information are set. FIG. 17A illustrates a privilege setting screen 1700 of the network information to be displayed for each role. The privilege setting screen 1700 is, for example, a screen as follows. A button (not illustrated) for transition to the privilege setting screen 1700 is provided on the setting screen 550 of FIG. 5B, the privilege setting screen 1700 is displayed in the case where pressing of this button is received. Note that the button (not illustrated) for transition to the privilege setting screen 1700 may be configured to be capable of receiving the pressing operation in the case where the login user is the administrator. Accordingly, the button (not illustrated) for transition to the privilege setting screen 1700 is configured not to receive the pressing operation, for example, configured to be displayed in a grayed-out manner for users of roles other than the administrator.

In the form of FIGS. 17A and 17B, the operation unit 113 displays the privilege setting screen 1700 in both of the case where an interface with multiple lines is selected and the case where an interface with a single line is selected on the interface selection screen 600. The privilege setting screen 1700 of FIG. 17A includes a setting display area 1701 in which names of privileges such as administrator, regular, guest, and custom roles and privileges associated with the respective names are displayed. On the privilege setting screen 1700, setting contents in which "administrator, display" is displayed in the first row means that the administrator has a privilege of browsing information on the lines selected on the interface selection screen 600. This means that in the case where the main line and the sub-line are selected on the interface selection screen 600, the administrator can browse information on both lines, and in the case where only the main line is selected, the administrator can browse information on this main line. Similarly, the regular user has the privilege of browsing the network information on the lines selected on the interface selection screen 600 by default. The guest user does not have the privilege of browsing the information on the lines selected on the interface selection screen 600 by default.

Each of the rows in the setting display area 1701 is a button. For example, in the case where a pressing operation of a button 1702 in which "regular, display" is displayed in the second row is received, this row goes into a selected state. In the case where a pressing operation of an edit display privilege button 1703 is received in the state where the button 1702 is selected, the operation unit 113 transitions to an individual privilege setting screen 1750 illustrated in FIG. 17B. Note that, in the case where the pressing operation of the edit display privilege button 1703 is received in a state where a button of another row is selected, an individual privilege setting screen for a user of the corresponding role is similarly displayed.

FIG. 17B is a diagram illustrating the individual privilege setting screen 1750 of the network information to be displayed for the regular user. On the individual privilege setting screen 1750 of FIG. 17B, the administrator can set and change the privilege of the network information to be displayed for the regular user to display or not-display. In the case where the screen transitions from the privilege setting screen 1700 of FIG. 17A to the individual privilege setting screen 1750 of FIG. 17B as described above, a setting value 1751 of "display" is in a selected state on the individual privilege setting screen 1750. FIG. 17B illustrates a state where a setting value 1752 of "not display" is then selected by the administrator. In the case where a pressing operation of an edit complete button 1753 is received in this state, the setting value of the privilege of the network information to be displayed for the regular user is changed to "not display". The changed setting value is written and saved in the HDD 205. Moreover, the screen displayed on the operation unit 113 also returns to the privilege setting screen 1700 of FIG. 17A. On the privilege setting screen 1700 in this case, display of the button 1702 in which "regular, display" has been displayed is changed to "regular, not displayed".

Unlike the example explained in FIGS. 16A and 16B, the example explained in FIGS. 17A and 17B is configured such that the setting can be selected also in the case where the setting value indicating that the MFP 101 is provided with only the main line is selected on the interface selection screen 600.

As explained above, also in the present embodiment, the administrator can set the privilege of the network information to be displayed depending on the role as desired. Since this allows the privilege to be flexibly set depending on an organization, the usability can be further improved. Moreover, since the administrator can set the privilege of the network information to be displayed as desired also for the user of the customized role such as the custom role, more flexible privilege setting is possible.

### Fourth Embodiment

In the present embodiment, explanation is given of an example in which the user can flexibly set a portion where the network information is displayed. In the first embodiment, the example based on the process of the flowchart illustrated in FIG. 8 is explained, and in the second and third embodiments, the example based on the process of the flowchart illustrated in FIG. 14 is explained. The present embodiment may be based on the process of any of the flowcharts. Since a basic configuration and the like are similar to those in the example explained in the first embodiment, differences are mainly explained.

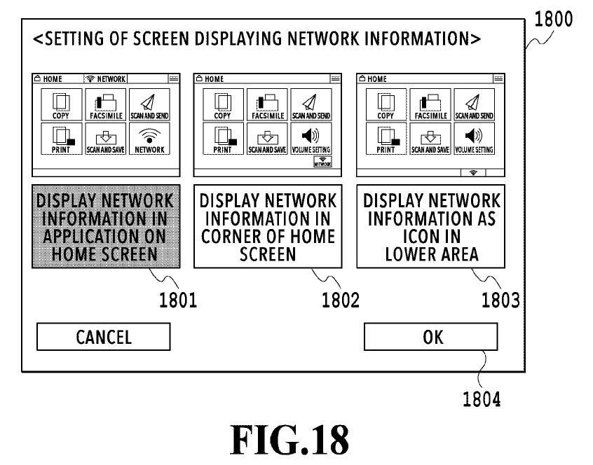

FIG. 18 is a diagram illustrating an example of a privilege setting screen 1800 in which a screen for displaying the network information is set. The privilege setting screen 1800 is, for example, a screen as follows. A button (not illustrated) for transition to the privilege setting screen 1800 is provided on the setting screen 550 of FIG. 5B, and the privilege setting screen 1800 is displayed in the case where pressing of this button is received. Note that the button (not illustrated) for transition to the privilege setting screen 1800 may be configured to be capable of receiving the pressing operation in the case where the login user is the administrator. Accordingly, the button (not illustrated) for transition to the privilege setting screen 1800 is configured not to receive the pressing operation, for example, configured to be displayed in a grayed-out manner for users of roles other than the administrator.

The privilege setting screen 1800 is configured such that a position on the screen where the network information is to be displayed can be set. The network information of the present embodiment is an icon indicating the network status. In a default state, a setting value 1801 of "display network information in application on home screen" is set. In the case where the setting value 1801 is set, the network information is displayed in the network button 405 and the shortcut button 407 of the menu screen 400. Note that, in this example, the shortcut corresponding to the network button 405 is assumed to be set in the shortcut button 407 as explained in the first embodiment.

In the case where a setting value 1802 of "display network information in corner of home screen" or a setting value 1803 of "display network information as icon in lower area" is pressed and selected on the privilege setting screen 1800 and a pressing operation of an OK button 1804 is received, the setting is changed to the selected setting value.

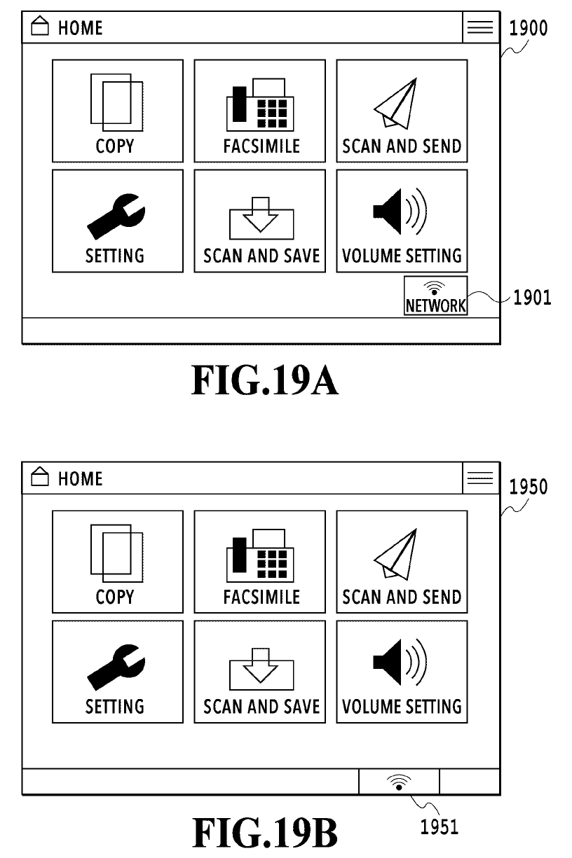

FIGS. 19A and 19B are diagrams illustrating examples of a position where the network information is displayed. In the case where the setting value 1802 of "display network information in corner of home screen" is set on the privilege setting screen 1800, the network information is displayed in a space at a corner of the menu screen like a network button 1901 on a menu screen 1900 illustrated in FIG. 19A. Reception of a pressing operation of the network button 1901 causes the operation unit 113 to transition to the network setting screen 500. Meanwhile, in the case where the setting value 1803 of "display network information as icon in lower area" is set, the network information is displayed in a lower area of the menu screen like a network button 1951 on a menu screen 1950 illustrated in FIG. 19B. Reception of a pressing operation of the network button 1951 causes the operation unit 113 to transition to the network setting screen 500. In the case where the setting is changed, the setting is written and saved in the HDD 205.

As explained above, according to the present embodiment, it is possible to improve customizability of the portion where the network information is displayed, and the administrator can more flexibly set a usage environment of the network.

### Other Embodiments

In the above-mentioned embodiments, explanation is given by using the roles of administrator, regular user, and guest user as examples of the information on the user. However, the examples of roles are not limited to these examples. The regular user may be the only role other than the administrator, or the guest user may be the only role other than the administrator. Alternatively, the custom role may be the only role other than the administrator. Furthermore, although the information on the user is explained as the roles for the sake of convenience, the information on the user may be described in other expressions such as user attributes.

Although explanation is given by using the MFP 101 as an example of the information processing apparatus in the above-mentioned embodiments, the information processing apparatus is not limited to the MFP 101. The information processing apparatus may be a PC, a smartphone, a tablet terminal, or the like. Alternatively, the information processing apparatus may be home electric appliances such as a television set, a refrigerator, or an air conditioner. The information processing apparatus explained in the present disclosure can be applied to any device as long as the device can connect to multiple networks and can display the network information.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to improve usability in a configuration of multiple networks.

This application claims the benefit of Japanese Patent Application No. 2025-042716, filed Mar. 17, 2025, which is hereby incorporated by reference herein in its entirety.

What is claimed is:

1. An information processing apparatus connectable to a plurality of networks, the information processing apparatus comprising:
one or more memories storing instructions; and
one or more processors which function as:
an obtaining unit configured to obtain information on a logged-in user; and
a display control unit configured to perform display control of displaying information on the plurality of networks in a first mode in a case where the information on the user obtained by the obtaining unit is first user information, and displaying the information on the plurality of networks in a second mode different from the first mode in a case where the information on the user obtained by the obtaining unit is second user information different from the first user information.

2. The information processing apparatus according to claim 1, wherein the information on the user is information indicating one of roles.

3. The information processing apparatus according to claim 2, wherein the roles include administrator and at least one of regular user or guest user.

4. The information processing apparatus according to claim 3, wherein, in a case where the first user information indicates the role of the administrator, an amount of the information displayed in the first mode is more than an amount of the information displayed in the second mode.

5. The information processing apparatus according to claim 3, wherein, in a case where the first user information indicates the role of the administrator, the number of networks displayed in the first mode is larger than the number of networks displayed in the second mode.

6. The information processing apparatus according to claim 3, wherein, in a case where the first user information indicates the role of the administrator, information on a main line and a sub-line is displayed as the information on the networks in the first mode, and information on one of the main line or the sub-line is displayed as the information on the networks in the second mode.

7. The information processing apparatus according to claim 3, wherein
the one or more processors further function as a setting unit configured to set information on a line to be used in the information processing apparatus among the plurality of networks,
in a case where the line set in the setting unit is a main line and a sub-line, the display control unit performs the display control, and
in a case where the line set in the setting unit is the main line alone, the display control unit does not perform the display control.

8. The information processing apparatus according to claim 7, wherein the setting unit is capable of setting the information on the line in a case where the information on the user indicates the role of the administrator.

9. The information processing apparatus according to claim 1, wherein the displayed information on the networks is an icon used to access a setting screen for setting of the networks.

10. The information processing apparatus according to claim 9, wherein an icon indicating a main line and a sub-line is displayed as the icon in the first mode, and an icon indicating one of the main line or the sub-line is displayed as the icon in the second mode.

11. The information processing apparatus according to claim 9, wherein the icon is an icon indicating a connection state of at least one of the networks.

12. The information processing apparatus according to claim 9, wherein the icon is an icon indicating a radio field intensity of at least one of the networks.

13. The information processing apparatus according to claim 9, wherein
the one or more processors further function as a first reception unit configured to receive designation of a position where the icon is to be displayed on a screen, and
the display control unit displays the information on the networks at the position for which the designation is received.

14. The information processing apparatus according to claim 1, wherein the displayed information on the networks corresponds to information displayed on a setting screen for setting of the networks.

15. The information processing apparatus according to claim 14, wherein, in a case where the first user information indicates a role of administrator, the setting screen of each of the plurality of networks is displayable in the first mode, and the setting screen of at least one of the plurality of networks is displayable in the second mode.

16. The information processing apparatus according to claim 1, wherein
the one or more processors further function as a second reception unit configured to receive changing of display modes in the first mode and the second mode, the first mode being the mode in the case where the information on the user is the first user information, the second mode being the mode in the case where the information on the user is the second user information, and
the display control unit performs the display control based on the changed display modes in a case where the changing of the display modes is received.

17. The information processing apparatus according to claim 16, wherein
the information on the user is information indicating one of roles,
the roles include administrator, at least one of regular user or guest user, and custom role based on default setting of the administrator, the regular user, and the guest user, and
the second reception unit is capable of receiving the changing of the display modes in the respective roles.

18. The information processing apparatus according to claim 1, wherein, in a case where the obtaining unit cannot obtain the information on the user, the display control unit performs display in a third mode that is different from the first mode and the second mode and in which the information on the networks is not displayed.

19. A control method of an information processing apparatus connectable to a plurality of networks, the control method comprising:
obtaining information on a logged-in user; and
performing display control of displaying information on the plurality of networks in a first mode in a case where the obtained information on the user is first user information, and displaying the information on the plurality of networks in a second mode different from the first mode in a case where the obtained information on the user is second user information different from the first user information.

20. A non-transitory computer readable storage medium storing a program which causes a computer to execute:
obtaining information on a logged-in user; and
performing display control of displaying information on the plurality of networks in a first mode in a case where the obtained information on the user is first user information, and displaying the information on the plurality of networks in a second mode different from the first mode in a case where the obtained information on the user is second user information different from the first user information.
